(19) United States
(12) Patent Application Publication
(10) Pub. No.: US 2025/0378343 A1
(43) Pub. Date: Dec. 11, 2025

(54) METHOD FOR VALIDATING THE PREDICTIONS OF A SUPERVISED MODEL FOR MULTIVARIATE QUANTATIVE ANALYSIS OF SPECTRAL DATA

(71) Applicant: COMMISSARIAT A L’ENERGIE ATOMIQUE ET AUX ENERGIES ALTERNATIVES, PARIS (FR)

(72) Inventors: Riccardo FINOTELLO, BURES SUR YVETTE (FR); Jean-Baptiste SIRVEN, PARIS (FR); Mohamed TAMAAZOUSTI, CLAMART (FR)

(21) Appl. No.: 18/877,218

(22) PCT Filed: May 24, 2023
(86) PCT No.: PCT/EP2023/063875

§ 371 Date: Dec. 19, 2024

(30) Foreign Application Priority Data
Jun. 21, 2022 (FR) FR2206060

(51) Int. Cl. G06N 3/09; G06N 3/0464

(52) U.S. Cl. CPC G06N 3/09; G06N 3/0464

(57) ABSTRACT

A computer-implemented machine-learning method for learning a multi-output prediction model is configured to jointly determine, based on a set of characteristic spectral data of a sample, at least one primary prediction of at least one first physical quantity characterizing a given species in the sample and at least one secondary prediction of at least one second physical quantity characterizing the species, the multi-output prediction model being trained using a set of annotated spectral data.

### CROSS-REFERENCE TO RELATED APPLICATIONS

This application is a National Stage of International patent application PCT/EP2023/063875, filed on May 24, 2023, which claims priority to foreign French patent application No. FR 2206060, filed on Jun. 21, 2022, the disclosures of which are incorporated by reference in their entireties.

### FIELD OF THE INVENTION

The invention relates to the field of quantitative analysis (for example determination of the concentration of chemical species contained in a sample) and supervised qualitative analysis (for example classification of samples based on spectral data, i.e. data that have a plurality of intensity values in various wavelength channels or spectral bands). The data may be both multi-or hyper-spectral data, in which the number of spectral bands varies from a few tens into the hundreds, and data derived from emission or absorption spectra of a chemical species, containing thousands of wavelength channels.

The invention relates to a new multi-variate analysis method for quantitatively analyzing chemical species contained in a sample, based on spectral data acquired using a spectroscopy technique. One objective of the invention relates to determination of a measure of the confidence in the predictions of the model used for the quantification, using a multi-output algorithm. More precisely, in the context of the invention, the model returns both the primary prediction, for example the value of the concentration of a species, based on the spectrum, and secondary outputs regarding tasks related to this prediction, hence the need for a multi-output system. These secondary predictions are then used to measure confidence in the primary prediction. In other words, unlike a conventional quantification approach that predicts only the main output, for example the concentration of the species of interest, the invention aims to simultaneously predict quantities that are directly verifiable (i.e. present in the experimental data both during learning and during the inference phase) in the experimental data and that thus make it possible to ensure the reliability of the predicted concentration.

### BACKGROUND

One possible application of the invention relates to determination of the concentration of chemical elements and of a reliability indicator of the predictions based on spectral data that is for example acquired by means of a LIBS technique, LIBS standing for laser-induced breakdown spectroscopy. The invention is not limited to this particular technique-it may be applied to any type of spectroscopy technique that produces multi-or hyper-spectral data or spectral data on emission or absorption of chemical species.

Specifically, the LIBS technology allows material to be analyzed by focusing a laser beam on the surface of a sample. The emission of a plasma resulting from this focus is collected by a spectrometer. The data acquired by this method are spectral data that correspond, for each focal point on the surface, to an emission spectrum comprising atomic and molecular lines that are characteristic of the elementary chemical composition of the sample. The intensity of these lines increases non-trivially with the concentration of chemical elements present in the sample. Calibration is carried out using a plurality of standards, i.e. samples the concentrations of the species of which are known beforehand, to obtain a model that allows spectral signatures to be related to the concentration of the species. This model may then be used to predict the unknown concentration of a species, based on a spectrum. Once the model has been defined, methods exist that allow a measurement of the uncertainty in predictions made by the model (confidence intervals for example) to be defined. However, it is complicated to evaluate the nature of the uncertainties in the inference phase: it may be impossible or very difficult to determine whether the uncertainties are entirely related to statistical fluctuations, or whether the standards used to define the quantitative model are actually representative of the samples to be measured. Furthermore, without particular weighting of the data, the calibration is characterized by relative uncertainties that increase as the concentration of species in the standards decreases, down to the detection limit. In fact, a level of 100% relative uncertainty is sometimes used as a definition of the detection limit. Generally, the limitations of the LIBS technique are typical of any spectroscopy technique: validation of the reliability of the predictions is always problematic and relative uncertainties close to the detection limit are by definition high.

### SUMMARY OF THE INVENTION

The invention aims to overcome these limitations by proposing to use: a multi-variate, multi-output quantification model to obtain both predictions of species concentrations and values that may be used to determine the confidence therein. To this end, the invention introduces a technique for validating the predictions of quantitative models and for establishing a measure of the confidence in the predictions or for identifying the presence of anomalies (i.e. predictions that do not have a good level of confidence).

A multi-variate analysis model allows uncertainties in the determination of the concentration of species to be reduced so as to obtain more reliable and accurate measurements in the context of the invention.

The invention aims to solve problems related to determination of the concentration of species based on spectral data, which may be produced by LIBS or by other spectroscopy methods (e.g. multi- or hyper-spectral imaging). In general, this type of data is characterized by spectra specific to the species present in a sample. Quantitative analysis of the spectral signatures (for example, using the intensity of the emission or absorption lines of chemical elements) ultimately allows the concentration of the species to be determined. In this context, a plurality of problems may arise.

Conventional calibration methods provide a prediction of the concentration of a species in a sample. Since the model is defined using known standards, there is no way to verify that the standards used to define the model are representative of the samples to be measured, even though this is necessarily an assumption underlying use of the model. In other words, it is not possible to verify whether the samples to be measured lie outside the learning distribution, and, therefore, to verify the generalization of the learning model. For example, the experimental conditions of a measurement taken using the model may not correspond to the experimental conditions used when training the model because various uncontrolled external variables related to the instrumentation, environmental conditions, or the sample itself may change them.

The trained model nonetheless makes a prediction based on a measurement, without verifying that the data used to train it are actually representative of the real data. There is therefore a need for a tool that will make it possible to verify the reliability of predictions when the conditions of use of the model differ slightly from the learning conditions, or in contrast to ensure that the conditions of use of the model have not changed.

Currently, quantification of chemical species based on spectral data is achieved using various uni-variate methods (which only partially take into account the information contained in the spectra) or multi-variate methods (which exploit all or almost all of the content of the spectra). One example of such methods is given in reference [1]. Among all the variables available in a spectrum (wavelength channels or spectral bands) uni-variate methods use the information contained in one variable, usually the intensity of an emission line (or the sum of the intensities of neighboring channels) at a given wavelength, or in one spectral band associated with the species that it is desired to analyze. This information may then be used to obtain a calibration function (for example a straight line) that relates the concentration of the species in question to the intensity of the signal for each of the standards, for which the concentration of the species is known. Mathematically, this procedure defines a relationship between concentration and spectral intensity. The calibration function may then be used to obtain predictions of the concentration of a species in an unknown sample by reversing this relationship, and for example by means of an interpolation such as described in reference [2].

Other multi-variate methods have also been studied, these in particular using algorithms based on principal component analysis and multiple linear regression (see reference [3]). Neural networks (described in [4]) have already been employed in the context of LIBS, application thereof being based either on use of the intensity of certain lines selected beforehand (as proposed in [5]), or on coupling principal component analysis and neural networks to achieve a multi-output regression (as proposed in [6]), or on use of information contained in time-resolved spectra (as proposed in [7]). The result of the analysis is always a prediction of the concentration of a species (or a plurality of species in [6]) depending on a plurality of variables (hence the expression “multi-variate analysis”).

In recent years, deep-learning techniques, given that they are highly capable of extrapolation, have become relevant to sample classification (see for example [8], [9]: these analyses use high-performance algorithms (such as convolutional neural networks) to predict the category of chemical species contained in samples. Although such architectures achieve good classification results, the level of confidence in the predictions cannot be directly established by the model. As the authors of references [10] and [11] highlight, conventional indicators such as mean squared error may be very misleading depending on concentration level: the authors therefore suggest using various indicators for each sub-population of data, in order to better assess the performance of the model. Other approaches have also been proposed with a view to verifying the robustness of a model, such as randomization of model reference values in [12]: the authors describe a technique making it possible to test whether a given prediction of the model is obtained by chance.

In general, known analyses focus on predicting a single variable (concentration), based on input data of different dimensions [5], [7]. However, some studies have employed multi-output models, for example in [13] to simultaneously predict the concentrations of a plurality of chemical elements using the PLS2 technique. The first example of multi-output regression using neural networks was described in [6]. These multi-output algorithms were used to obtain more information at the same time (in particular the concentrations of a plurality of elements instead of one), while using the same input data.

However, prior-art techniques do not make it possible to determine an indicator of the reliability of the concentration predictions delivered by the various proposed learning models.

Unlike the solutions of the prior art, the invention deals with validation of the predictions, rather than validation of the model. The invention relates to a technique allowing a measure of the confidence in the predictions to be obtained using information available at any time, even in unknown data, and thus them to be directly compared to a ground-truth value. In the invention, this is achieved via use of multi-output models, and in particular via use of deep-learning architectures capable of efficiently processing the information contained in the data.

The invention relates to a method for validating predictions based on a multi-output model. In other words, the secondary outputs are measurable experimentally so as to allow the relevance of the primary output, which is assumed to be unknown in the inference phase, to be evaluated.

The proposed invention comprises an additional step, with respect to prior-art methods. Multi-output algorithms are used to predict secondary outputs that are verifiable in the experimental data, in order to be able to ensure a degree of confidence in the predictions. This is not possible when only the concentration (or concentrations) of the chemical species is predicted.

The invention makes provision to use algorithms trained not only to predict the concentration of a species based on spectral data, but also to deliver secondary outputs predicting additional quantities, such as the emission or absorption intensity of one or more spectral lines or bands characteristic of the species analyzed. These additional data must be experimentally measurable and verifiable during inference. Moreover, the prediction of these values must be sufficiently complicated for the model, compared to the primary prediction. In other words, the prediction must regard a non-trivial task (the complexity of which is comparable to the complexity of the primary prediction) and be based on the input data, in order to avoid imbalance during the learning process. For example, it is possible to use the intensity of spectral lines or bands integrated over neighboring wavelength channels. Conversely, it is not recommended to simply use the intensity of the lines in the spectra, which would be a trivial task to solve (it is a single component of the input data). This type of information makes it possible to obtain, in the inference phase, additional information (hence the use of multi-output algorithms) that may be related to real data.

The invention makes it possible to provide, for any concentration prediction, an indicator of the reliability of the prediction allowing, for example, certain measurements subject to uncontrolled variables making the prediction delivered by the model, based on these measurements, unreliable to be discarded.

One subject of the invention is a computer-implemented machine-learning method for learning a multi-output prediction model configured to jointly determine, based on a set of characteristic spectral data of a sample, at least one primary prediction of at least one first physical quantity characterizing a given species in the sample and at least one secondary prediction of at least one second physical quantity characterizing said species, the multi-output prediction model being trained using a set of annotated spectral data.

According to one particular aspect of the invention, the multi-output prediction model is a multi-task neural network and is implemented by means of a first common learning engine configured to extract, from sets of spectral data received as input, representations common to the various tasks to be solved and of a plurality of learning engines specific to each task to be solved, which each receive as input said common representations and which deliver as output a prediction corresponding to the task to be solved.

According to one particular aspect of the invention, the common learning engine is a convolutional neural network and the specific neural networks are convolutional neural networks supplemented by fully connected neural layers.

According to one particular aspect of the invention, said species is a chemical species, the primary prediction is a value of a concentration of the chemical species and the secondary prediction is an intensity value of a spectral line for at least one given wavelength or at least one wavelength band of given width.

Another subject of the invention is a computer-implemented prediction model obtained using the machine-learning method according to the invention.

The invention also relates to a computer-implemented quantitative-analysis method for quantitatively analyzing spectral data comprising implementing the prediction model according to the invention to determine, based on a spectrum measured on a sample, at least one primary prediction of at least one first physical quantity characterizing a given species in the sample and at least one secondary prediction of at least one second physical quantity characterizing said species, the method further comprising a step of computing a reliability indicator of the at least one primary prediction based on an indicator of the discrepancy between at least one secondary prediction and a value of the corresponding second physical quantity measured on the spectrum.

According to one particular aspect of the invention, the reliability indicator is equal to the relative error between the intensity value predicted via implementation of the prediction model and the corresponding intensity value measured on the spectrum.

According to one particular aspect of the invention, the reliability indicator is equal to the discrepancy, in absolute value, between the intensity value predicted via implementation of the prediction model and the corresponding intensity value measured on the spectrum divided by the standard deviation of this discrepancy.

In one variant of embodiment, the quantitative-analysis method according to the invention further comprises implementing a classification model configured to classify the predictions in respect of concentration of chemical species into two classes corresponding to normal values and anomalies, based on predictions of spectral-line intensity values or on reliability indicators.

According to one particular aspect of the invention, the measured spectrum is acquired by means of a LIBS method, LIBS standing for laser-induced breakdown spectroscopy.

The invention also relates to a computer program comprising instructions for executing a method according to the invention, when the program is executed by a processor and to a processor-readable recording medium on which is recorded a program comprising instructions for executing a method according to the invention, when the program is executed by a processor.

### BRIEF DESCRIPTION OF THE DRAWINGS

Other features and advantages of the present invention will become more apparent on reading the following description in relation to the following appended drawings.

FIG. 1 shows one example of spectral data characterizing a sample containing various chemical species,

FIG. 2 shows a schematic illustrating learning and use of a multi-output prediction model according to the invention,

FIG. 3 shows a schematic of one example of implementation of the prediction model according to the invention by means of one or more convolutional neural networks,

FIG. 4 shows one example of a table of results of learning and of analysis of the secondary outputs.

### DETAILED DESCRIPTION

Below, the description of the invention is given in the context of the use of LIBS technology, but the invention is not limited to this technique and applies more generally to any type of spectral data, whether multi-or hyper-spectral.

LIBS technology allows material to be analyzed by laser ablation and spectroscopy. The data acquired via this technique are spectral data that correspond, for each point in an area, to an emission spectrum comprising atomic and molecular lines that are characteristic of the elementary chemical composition of the sample.

LIBS spectral data are obtained by focusing a laser beam on a point on a surface to be analyzed. The emission of a plasma resulting from this focus is collected and processed by spectroscopy to obtain an emission spectrum of atomic lines (or molecular bands). The process is iterated for each point in the area to be analyzed.

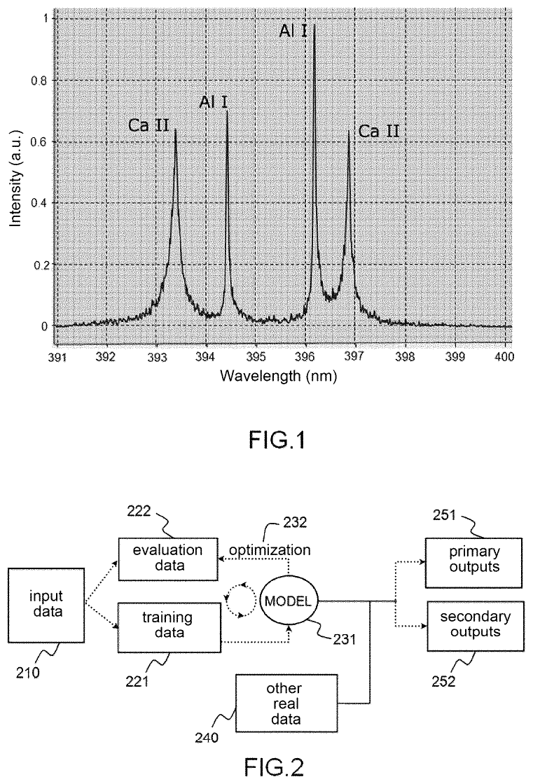

FIG. 1 shows, by way of illustration, one example of a spectrum of atomic lines 101 obtained for a sample having a certain chemical composition. In FIG. 1, the spectral signatures of certain chemical elements (Ca, Al) corresponding to atomic lines in given wavelength channels have been identified.

One objective of the invention is to determine a prediction model capable of estimating a concentration of a chemical element based on an automatic analysis of a spectrum such as that of FIG. 1, and also of delivering a reliability indicator of the delivered estimate.

FIG. 2 shows, in a schematic, a method for learning and using a prediction model according to the invention.

The method consists, in a learning phase, in determining a prediction model 231 configured to determine, based on spectra measured on given samples, a concentration of one or more chemical species on the one hand and a prediction of the intensity of one or more atomic lines (or molecular bands) in the spectrum on the other hand.

The method then consists, in a use phase, in using the trained model to determine these predictions on new measured spectral data. The secondary outputs of the model are used to determine a reliability indicator of the predictions.

More precisely, in the learning phase, the method uses as input spectral input data 210 taking the form of a plurality of sets of spectra obtained by LIBS, to characterize a given sample. The spectral data 210 are labelled, i.e., for example in the case of quantitative analysis, the concentrations of the various chemical elements to be quantified in the sample are known.

In other words, the input data 210 are a set of pairs each associating a spectrum with a concentration of one or more chemical elements in a sample of a given type. A sample is for example characterized by a type of material and a concentration of certain chemical elements in the material.

The input data 210 are separated into a first sub-set of training data 221 and a second sub-set of evaluation data 222. The model 231 is trained using the training data 221 and then optimized on the evaluation data 222 in an optimization cycle 232, so as to determine the best hyperparameters of the model 231.

The choice of the percentage of realizations used for the purposes of learning 221 may depend on the computational medium and on the type of data, with a view to maximizing architecture learning capacity. For example, for a dataset containing 100000 realizations typically 80% may be used for learning, but for datasets with millions of realizations the percentage may increase, unless the computational medium does not allow it. The training data 221 are used to compute model parameters directly, while the evaluation data 222 are used to evaluate the predictions and to optimize the model 231.

The prediction model 231 is a multi-variate, multi-output statistical model. It receives as input whole spectra by way of input data, and is trained to predict on the one hand a first set of primary outputs 251 corresponding to one or more predictions of the concentration of one or more chemical species and on the other hand a second set of secondary outputs 252 corresponding to one or more predictions of intensity values of atomic lines in certain wavelength ranges.

Once the model 231 has been trained, it may be applied to a new set 240 of spectral data. The first set of predictions 251 is used to determine the concentrations of chemical species in the sample on which the input spectrum 240 was measured. The second set of predictions 252 is processed to determine a measure of the confidence in the first predictions 251.

The confidence measure is based on interpretation in terms of probability (for example using the probability distribution of a given estimator, as presented below) or of relative error of the predictions of the secondary outputs 252 of the model 231. These outputs must predict quantities, related to prediction of the concentration of the species, present in the unknown real data 240, so that a comparison between real and predicted values allows the reliability of the learning and predictions to be quantified. Since the secondary outputs 252 were trained using the same representation of the input data 210, the secondary predictions 252 are related to the predictions 251 of the concentration of the species and they share at least one sub-set of the weights of the model (so-called hard parameter sharing). It may thus be assumed that a reliable secondary-output result may lead to equally reliable concentration predictions, i.e. the capacity of generalization of the model to the primary and secondary outputs is comparable.

The input data 210 used to train the model are representative of the standard samples used to define the model: a number of spectra may represent the same standard. These data may be pre-processed to reduce experimental fluctuations in spectral intensity values. For example, in one embodiment of the invention, each spectrum may be normalized by the intensity of a given line or band, or be pre-processed by using an SNV method (SNV standing for standard normal variate) or any other pre-processing method. In another embodiment, for each standard, the average spectral intensity value of the spectrum at a given wavelength may be used to determine outliers. For example, before defining the model, spectra the intensity value of which at a given wavelength is outside an arbitrary interval (for example outside the 5th and 95th percentiles, or 1st and 99th percentiles) may be rejected. The interval depends on the measurement conditions and on the number of realizations for each standard: if this number is high, a larger interval may be chosen (1st and 99th percentiles, for example). In another embodiment, these two types of pre-processing may be combined. The real data 240 used during the phase of use of the model absolutely must be pre-processed in the same way as the input data, but it is possible to keep outliers in the unknown real data 240. Specifically, if the trained model is highly capable of generalization, outliers will be correctly processed during the inference phase. The aim is to learn to perform the prediction task based on a reliable representation of the standard: a good model must be capable of extrapolating the necessary information to cases where the samples contain defects.

Evaluation of the model using evaluation data 222 may be achieved using each spectrum directly as input datum. It is then possible to compute the average of the predictions and to associate a discrepancy with the predictions in order to better evaluate the performance of the algorithm (and to train the algorithm on more complex cases where noise may produce significant differences between spectra, even those obtained from the same standard).

In one embodiment of the invention, to reduce the impact of noise during the inference phase, it is possible to compute the average spectrum of the real data 240 beforehand and to use it as input datum representative of the sample.

In one embodiment of the invention, the primary outputs 251 are composed of the concentrations of the analyzed chemical species. The secondary outputs 252 of the model contain the intensities of emission (or absorption) lines (or molecular bands) associated with the same chemical species in the case of spectral data, or the intensity measured in a spectral band in the case of multi-or hyper-spectral data. In the context of uni-variate models, the intensities of spectral lines or bands are used for prediction of concentration. Thus, the decision to include these two elements in the secondary outputs of the model makes it possible to obtain secondary predictions corresponding to physical quantities related to the concentrations of chemical species.

In one embodiment of the invention, the quantitative-analysis method comprises a step of computing a reliability indicator of the primary outputs of the model based on the secondary outputs of the model. For example, the reliability indicator corresponds to a measurement of the discrepancy between the predicted intensity output from the model and the real intensity directly measured on the input data 240. For example, the Student t-value of the discrepancy between the two values may be computed using the formula t=|I_{predicted}−Iᵣₑₐₗ|/σ, where I_{predicted} is the average intensity 252 of the sample as predicted by the model 231, Iᵣₑₐₗ is the real average intensity measured on the input data 240 and σ is the standard deviation of the difference (i.e. the square root of the sum of squares of the discrepancies between the predicted and real intensities). Lastly, it is possible to choose a confidence level as normal in statistical analyses (for example 95% or 99%) to define a threshold tₗᵢₘᵢₜ, depending on the number of realizations for each sample (the degrees of freedom). If the prediction I_{predicted} leads to a value t>tₗᵢₘᵢₜ, it is deduced therefrom that the prediction of the concentration 251 is biased, this allowing this prediction to be rejected on the basis of an interpretation in terms of probability (i.e. the hypothesis that the difference between the prediction and the real value is due solely to statistical fluctuations is rejected). If the prediction I_{predicted} leads to a value t≤tₗᵢₘᵢₜ, the available evidence does not allow the prediction 251 to be rejected and hence the concentration prediction, associated with the intensity prediction, may be accepted with a level of confidence quantifiable by tₗᵢₘᵢₜ.

Alternatively, it is possible to use a simple threshold on the relative error between the true value of the intensity and its predicted value r=|I_{predicted}−Iᵣₑₐₗ/Iᵣₑₐₗ: values lower than the chosen value need not be rejected, because their distance to the true value is mainly due to statistical fluctuations. This estimator is independent of the standard deviation of the emission intensity and may be used as a first statistical test, directly applied to the intensity values: if the prediction does not pass this test, then it may be rejected without risk, because the error is too great. The (Student's) t-test may then be used as a refinement of the procedure, because it also depends on the variance of the data.

The invention thus provides a method based on a multi-output machine-learning algorithm that allows information explicitly contained in the experimental data (the intensity of the emission lines of the spectrum), and which is therefore verifiable (by direct measurement on the spectrum), to be used to obtain an interpretation of concentration predictions in terms of probability. The invention thus provides a method for quantitatively characterizing the confidence in these predictions based on the error in the secondary outputs. In particular, these predictions absolutely must have elements common with elements verifiable in the real data 240, in order to allow comparison. Results may then be rejected (or not rejected) using statistical tests.

In one embodiment of the invention, as the characterization of the confidence in the predictions is quantitative, the secondary predictions or the result of the statistical tests may be coupled with a classification algorithm to determine anomalies in the analyzed samples. In other words, the discrepancy between the predicted and real values of the secondary outputs may be used as input datum of a classification algorithm trained to recognize normal values and anomalies in manufacture, composition or measurement. In another embodiment, it is possible to directly use an arbitrary threshold on the t-values or relative errors computed based on the predictions to determine whether an anomaly is present.

In one embodiment of the invention, the prediction model 231 may for example

be a multi-linear model (such as the PLS2 model described in reference [13]), or a decision tree (or ensemble-learning variants thereof such as random forests or gradient boosting), or a support vector machine. The fundamental point of the model is the ability to use a common representation of the input data to obtain multi-output predictions at the same time, i.e. an approximation of the composition of the function ƒ·g, where g: [symbol] →A⊂ [symbol] and ƒ: A→ [symbol] , N being the dimension of the spectra, L being the dimension of the common representation and M being the number of predictions output from the model, such that M≥2, using the same set of parameters for the definition of the model. In this way, the model first computes a new representation of the input data (the spectra), which may then be used to generate the predictions.

Generally, to train the model 231, it is necessary to define a learning function (or loss function)

$${ℒ}_{i} ( {y}_{real}^{( i )} , {y}_{predicted}^{( i )} )$$

for output i of the model

$$( {y}_{real}^{( i )} and {y}_{predicted}^{( i )} )$$

being the real and predicted values of output i): this makes it possible to define the objective of the training and to measure the discrepancy between the predicted and real values (in supervised learning, the real values are known during learning). Thus, loss functions exist that are typically dedicated to regression learning, unlike the loss functions typically used for classification tasks. In various embodiments of the invention, a mean-squared-error function or mean-absolute-error function may be used. In another embodiment of the invention, these functions may be combined into a so-called Huber loss function, as described in reference [14] and defined by:

$${H}_{δ} ( y , \hat{y} ) = \frac{1}{2} {( y - \hat{y} )}^{2} Θ ( \vert y - \hat{y} \vert - δ ) + δ ( \vert y - \hat{y} \vert - \frac{δ}{2} ) Θ ( δ - \vert y - \hat{y} \vert ) .$$

where δ forms part of the hyperparameters to be optimized in the cycle of optimization 232 of the model and Θ is the Heaviside step function, which takes the value 1 for all strictly positive real numbers and the value 0 for strictly negative real numbers. This function allows outliers in the datasets to be taken into account directly.

Once the loss function

$${ℒ}_{i} ( {y}_{real}^{( i )} , {y}_{predicted}^{( i )} )$$

has been selected for output i of the model, the overall loss function of the model is defined as a linear combination of the loss functions specific to each output:

$${ℒ}_{overall} ( {Y}_{real} , {Y}_{predicted} ; Ω ) = {\sum }_{i = 1}^{N} {ω}_{i} {ℒ}_{i} ( {y}_{real}^{( i )} , {y}_{predicted}^{( i )} ) ,$$

where N is the number of outputs of the model,

$${Y}_{real} = {\{ {y}_{real}^{( i )} \}}_{i ∈ \{ 1 , … , N \}}$$

is the set of real values specific to each output,

$${Y}_{predicted} = {\{ {y}_{predicted}^{( i )} \}}_{i ∈ \{ 1 , … , N \}}$$

is the set of predictions of the outputs of the model, and Ω={ωᵢ∈ [symbol] }_{i∈{1, . . . ,N}} is the set of coefficients of the linear combination of loss functions. The coefficients ωᵢ are hyperparameters of the model 231.

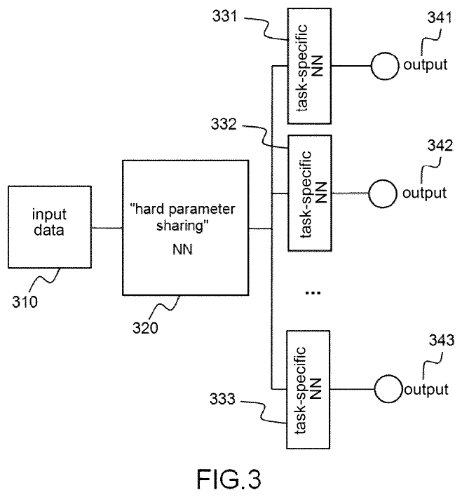

In another embodiment of the invention, the model 231 is implemented by means of one or more neural networks. One example of the architecture of the model 231 has been shown in FIG. 3.

In one embodiment, the constituent neural networks of the model 231 are convolutional neural networks. A convolutional neural network is implemented via a set of convolutions by vectors that extend in the direction of the wavelength channels of the spectra. The input data are scanned using a plurality of convolution filters in order to obtain both the primary predictions 251 and the secondary predictions 252 from a multi-output model.

These neural networks may be deep, with a number of hidden layers, and connect convolution and activation operations, with their trainable weights. The contribution of this type of algorithms is direct use of the information contained in the spectra: by using a convolution operation, relationships between neighboring wavelength channels can be maintained and physical information contained in profiles of the spectral lines (or spectral bands), such as emission or absorption intensity and profile width, may be used. More generally, other types of neural-network architectures, such as fully connected neural networks (based on multilayer perceptrons such as described in [16]) or graph neural networks such as described in [17], may also be used: a sufficient condition of the invention is the ability to form multi-output architectures, there being no specific restrictions on the type of neural network.

In the example of FIG. 3, a multi-task network (as described in reference [20]) has been shown. The difference between a multi-task network and a multi-output network is related to the processing of the representations of the data in the hidden layers: a multi-output network uses a common representation without subsequent transformations, but a multi-task network makes it possible to use a common representation and then to use branches specialized in specific tasks. In this sense, a multi-task network is a multi-output network, but the reverse is not true. The use of a multi-task architecture makes it possible to solve many problems related to overfitting of the training data and to limit the impact of outliers on the predictions (as for example mentioned in reference [18]).

The algorithms used may be based on multi-task deep convolutional neural networks. This gives the models the ability to analyze spectra directly, by formulating a new common representation of the data, and to predict with high accuracy either the concentrations of species of interest or, for example, the intensity of spectral emissions associated with the species. These predictions may then be interpreted by probability models via examination of the discrepancy between the predicted and real values.

The input data 310 of the model have already been described: it is a question of spectra acquired using a spectroscopy technique, and which are optionally pre-processed. The first block of the model 320 has been represented by a neural network comprising one-dimensional convolutional layers. This first block has the task of learning a common representation of the spectra using the same set of weights and parameters (so-called hard parameter sharing). A number of examples of embodiment of multi-task neural networks are given in reference [19]. The aim of this first block is to convert the input data into a representation capable of providing predictions for all the tasks at the same time.

The outputs/tasks of the model 341-343, comprising the concentrations of the species analyzed and the values used to determine confidence, are computed using other specific convolutional networks 331-333: each network makes it possible to compute subsequent transformations based on the common representation and to obtain a specific result. For example, the model computes the secondary outputs (the intensities of the lines present in the spectra) starting with this common representation and then processing it in specific branches. Thus, the model does not simply “read” intensity in the spectra, but is obliged to first find an appropriate representation of the input data and then process this information. This type of network is a non-negligible improvement over conventional networks.

The convolutional neural networks 331-333 take as input a vector of common characteristics that is extracted from the input data via the first neural network 320, and produce as output a prediction in scalar form. For this purpose, each convolutional neural network 331-333 comprises a last layer that is fully connected to an output.

One example of a possible architecture of the multi-task model of FIG. 3 is defined by:
a first neural network 320 formed by 3 convolutional layers with, respectively:
   i. 64, 40 and 16 filters,
   ii. kernel size: 5, 3 and 2 wavelength channels,
   iii. interval: 3, 2 and 1 wavelength channels,
      neural networks for solving specific tasks 331-333 having the same hyperparameters as the first neural network 320 and supplemented by two fully connected layers of 16 neurons and 1 neuron, respectively (each network 331-333 predicts a real number).

The activation function after each hidden layer is for example of the LeakyReLU type (with a slope of 0.03). For example, the learning rate is set to 10⁻³.

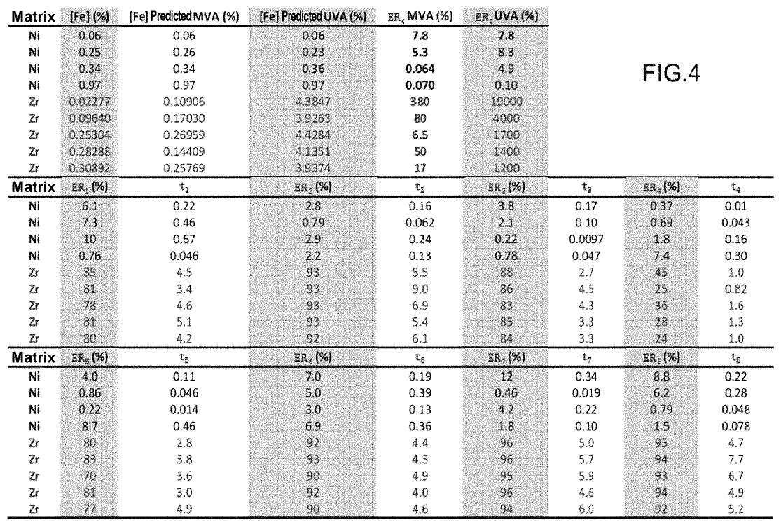

FIG. 4 shows a table collating the results of calibration of the concentration of iron (Fe) in a matrix of nickel (Ni) and a matrix of zirconium (Zr). 25 laser shots were recorded for each sample and each spectrum was formed by 68000wavelength channels. The secondary outputs were the values of the intensity of the Fe emission lines at 373.49 nm, 358.12 nm, 373.71 nm, 374.56 nm, 382.04 nm, 385.99 nm, 404.58 nm and 438.35 nm. Learning was carried out only on spectra of Ni standards (results obtained in an independent set of tests). As shown in the table, the multi-variate architecture (MVA), based on multi-task learning, was able to deliver more accurate predictions than the classical uni-variate method (UVA) on matrices of the same nature as those used for learning purposes. The multi-task architecture was also able to provide a measurement of the reliability of the predictions obtained for the Ni matrices, through use of a measurement of the confidence in the intensities predicted for the emission lines (in this case tₗᵢₘᵢₜ=t_{α,ν}=2.485, where the confidence level is α=0.99 and the degrees of freedom are ν=25). The table also shows the ability to generalize to a Zr matrix, of different nature to the training samples: the neural network is able to considerably reduce the error in the extrapolation regime. However, the multi-task architecture allows the reliability of the predictions to be measured: the relative errors in the intensities of the emission lines (and the values t) in the samples of Zr are indeed very high. In this case, the Zr matrix was recognized as abnormal with respect to the training distribution.

The invention makes it possible to quantify the confidence in the predicted concentration using probability models based on a set of predictions of a multi-output model. The model is able to predict both species concentration and other quantities (for example, the intensity of emission lines of a chemical species). This makes it possible to determine both unknown quantities (for example species concentrations) and secondary quantities that may be directly verified in the spectra, and used to determine the level of confidence in the quantitative analysis.

The invention makes it possible to reduce uncertainties by using high-performance algorithms capable of processing, directly and completely automatically, the spectral signatures of species contained in the whole spectra.

The steps of the invention may be implemented by way of a computer program comprising instructions for its execution. The computer program may be recorded on a processor-readable recording medium.

Reference to a computer program that, when it is executed, performs any of the functions described above, is not limited to an application program running on a single host computer. On the contrary, the terms computer program and software are used here in a general sense to refer to any type of computer code (for example, application software, firmware, microcode, or any other form of computer instruction) that can be used to program one or more processors to implement aspects of the techniques described here. The computing means or resources may in particular be distributed (cloud computing), possibly via peer-to-peer technologies. The software code may be executed on any suitable processor (for example a microprocessor) or processor core or set of processors, whether provided in a single computing device or distributed between a plurality of computing devices (for example such as potentially accessible in the environment of the device). The executable code of each program allowing the programmable device to implement the processes according to the invention may be stored, for example, in the hard disk or in read-only memory. Generally, the one or more programs may be loaded into one of the storage means of the device before being executed. The central processing unit is able to control and direct the execution of the instructions or segments of software code of the one or more programs according to the invention, which instructions are stored in the hard disk or in the read-only memory or else in other of the aforementioned storage elements.

### REFERENCES

[1] V. Costa et al., “Calibration Strategies Applied to Laser-Induced Breakdown Spectroscopy: A Critical Review of Advances and Challenges,” J. Braz. Chem. Soc., 2021, doi: 10.21577/0103-5053.20200175.
[2] V. Motto-Ros, S. Moncayo, F. Trichard, and F. Pelascini, “Investigation of signal extraction in the frame of laser induced breakdown spectroscopy imaging,” Spectrochim. Acta Part B At. Spectrosc., vol. 155, pp. 127-133, 2019, doi: 10.1016/j.sab.2019.04.004.
[3] P. Yaroshchyk, D. L. Death, and S. J. Spencer, “Comparison of principal components regression, partial least squares regression, multi-block partial least squares regression, and serial partial least squares regression algorithms for the analysis of Fe in iron ore using LIBS,” J Anal Spectrom, vol. 27, no. 1, pp. 92-98, 2012, doi: 10.1039/C1JA10164A.
[4] I. Goodfellow, Y. Bengio, and A. Courville, Deep Learning. MIT Press, 2016.
[5] J. El Haddad et al., “Artificial neural network for on-site quantitative analysis of soils using laser induced breakdown spectroscopy,” Spectrochim. Acta Part B At. Spectrosc., vol. 79-80, pp. 51-57, 2013, doi: 10.1016/j.sab.2012.11.007.
[6] L. Narlagiri and V. R. Soma, “Simultaneous quantification of Au and Ag composition from Au—Ag bi-metallic LIBS spectra combined with shallow neural network model for multi-output regression,” Appl. Phys. B, vol. 127, no. 9, p. 135, 2021, doi: 10.1007/s00340-021-07681-y.
[7] C. Lu, B. Wang, X. Jiang, J. Zhang, K. Niu, and Y. Yuan, “Detection of K in soil using time-resolved laser-induced breakdown spectroscopy based on convolutional neural networks,” Plasma Sci. Technol., vol. 21, no. 3, p. 34014, 2019, doi: 10.1088/2058-6272/aaef6e.
[8] T. Chen, S. Kornblith, M. Norouzi, and G. Hinton, “A simple framework for contrastive learning of visual representations,” in International conference on machine learning, 2020, pp. 1597-1607.
[9] T. Chen et al., “Deep learning with laser-induced breakdown spectroscopy (LIBS) for the classification of rocks based on elemental imaging,” Appl. Geochem., vol. 136, p. 105135, 2022, doi: 10.1016/j.apgeochem.2021.105135.
[10] L.-N. Li, X.-F. Liu, W.-M. Xu, J.-Y. Wang, and R. Shu, “A laser-induced breakdown spectroscopy multi-component quantitative analytical method based on a deep convolutional neural network,” Spectrochim. Acta Part B At. Spectrosc., vol. 169, p. 105850, July 2020, doi: 10.1016/j.sab.2020.105850.
[11] L.-N. Li, X.-F. Liu, F. Yang, W.-M. Xu, J.-Y. Wang, and R. Shu, “A review of artificial neural network based chemometrics applied in laser-induced breakdown spectroscopy analysis,” Spectrochim. Acta Part B At. Spectrosc., vol. 180, p. 106183, June 2021, doi: 10.1016/j.sab.2021.106183.
[12] J. El Haddad, L. Canioni, and B. Bousquet, “Good practices in LIBS analysis: Review and advices,” Spectrochim. Acta Part B At. Spectrosc., vol. 101, pp. 171-182, November 2014, doi: 10.1016/j.sab.2014.08.039.
[13] R. B. Anderson, J. F. Bell, R. C. Wiens, R. V. Morris, and S. M. Clegg, “Clustering and training set selection methods for improving the accuracy of quantitative laser induced breakdown spectroscopy,” Spectrochim. Acta Part B At. Spectrosc., vol. 70, pp. 24-32, 2012, doi: 10.1016/j.sab.2012.04.004.
[14] P. J. Huber, “Robust Estimation of a Location Parameter,” Ann. Math. Stat., vol. 35, no. 1, pp. 73-101, 1964, doi: 10.1214/aoms/1177703732.
[16] F. Rosenblatt, The perceptron, a perceiving and recognizing automaton Project Para. Cornell Aeronautical Laboratory, 1957.
[17] F. Scarselli, M. Gori, Ah Chung Tsoi, M. Hagenbuchner, and G. Monfardini, “The Graph Neural Network Model,” IEEE Trans. Neural Netw., vol. 20, no. 1, pp. 61-80, 2009, doi: 10.1109/TNN.2008.2005605.
[18] J. Baxter, “A Model of Inductive Bias Learning,” J. Artif. Intell. Res., vol. 12, pp. 149-198, 2000, doi: 10.1613/jair.731.
[19] M. Crawshaw, “Multi-Task Learning with Deep Neural Networks: A Survey,” 2020, [Online]. Available: https://arxiv.org/abs/2009.09796
[20] R. Caruana, “Multitask Learning: A Knowledge-Based Source of Inductive Bias,” in Proceedings of the Tenth International Conference on Machine Learning, 1993, pp. 41-48.
[21] B. Xu, N. Wang, T. Chen, and M. Li, “Empirical Evaluation of Rectified Activations in Convolutional Network,” 2015, [Online]. Available: http://arxiv.org/abs/1505.00853

1. A computer-implemented machine-learning method for learning a multi-output prediction model configured to jointly determine, based on a set of characteristic spectral data of a sample, at least one primary prediction of at least one first physical quantity characterizing a given species in the sample and at least one secondary prediction of at least one second physical quantity characterizing said species, the multi-output prediction model being trained using a set of annotated spectral data.

2. The machine-learning method as claimed in claim 1, wherein the multi-output prediction model is a multi-task neural network and is implemented by means of a first common learning engine configured to extract, from sets of spectral data received as input, representations common to the various tasks to be solved and of a plurality of learning engines specific to each task to be solved, which each receive as input said common representations and which deliver as output a prediction corresponding to the task to be solved.

3. The machine-learning method as claimed in claim 2, wherein the common learning engine is a convolutional neural network and the specific neural networks are convolutional neural networks supplemented by fully connected neural layers.

4. The machine-learning method as claimed in claim 1, wherein said species is a chemical species, the primary prediction is a value of a concentration of the chemical species and the secondary prediction is an intensity value of a spectral line for at least one given wavelength or at least one wavelength band of given width.

5. A computer-implemented quantitative-analysis method for quantitatively analyzing spectral data comprising implementing a prediction model trained by means of the machine-learning method as claimed in claim 1 to determine, based on a spectrum measured on a sample, at least one primary prediction of at least one first physical quantity characterizing a given species in the sample and at least one secondary prediction of at least one second physical quantity characterizing said species, the method further comprising a step of computing a reliability indicator of the at least one primary prediction based on an indicator of the discrepancy between at least one secondary prediction and a value of the corresponding second physical quantity measured on the spectrum.

6. The quantitative-analysis method as claimed in claim 5, wherein the reliability indicator is equal to the relative error between the intensity value predicted via implementation of the prediction model and the corresponding intensity value measured on the spectrum.

7. The quantitative-analysis method as claimed in claim 5, wherein the reliability indicator is equal to the discrepancy, in absolute value, between the intensity value predicted via implementation of the prediction model and the corresponding intensity value measured on the spectrum divided by the standard deviation of this discrepancy.

8. The quantitative-analysis method as claimed in claim 5, further comprising implementing a classification model configured to classify the predictions in respect of concentration of chemical species into two classes corresponding to normal values and anomalies, based on predictions of spectral-line intensity values or on reliability indicators.

9. The quantitative-analysis method as claimed in claim 5, wherein the measured spectrum is acquired by means of a LIBS method, LIBS standing for laser-induced breakdown spectroscopy.

10. A computer program comprising instructions for executing a method as claimed in claim 1, when the program is executed by a processor.

11. A processor-readable recording medium on which is recorded a program comprising instructions for executing a method as claimed in claim 1, when the program is executed by a processor.
